(19) United States
(12) Patent Application Publication
(10) Pub. No.: US 2023/0027330 A1
(43) Pub. Date: Jan. 26, 2023

(54) FUEL CELL ELECTRIC VEHICLE AND CONTROL METHOD OF THE SAME

(71) Applicant: TOYOTA JIDOSHA KABUSHIKI KAISHA, Toyota-shi (JP)

(72) Inventor: Ryosuke OYA, Toyota-shi (JP)

(73) Assignee: TOYOTA JIDOSHA KABUSHIKI KAISHA, Toyota-shi (JP)

(21) Appl. No.: 17/808,636

(22) Filed: Jun. 24, 2022

(30) Foreign Application Priority Data
Jul. 26, 2021 (JP) 2021-121572

(51) Int. Cl. B60L 3/00; H01M 8/043; H01M 10/48; B60L 50/75; B60L 58/40

(52) U.S. Cl. CPC B60L 3/0046; H01M 8/043; H01M 10/48; B60L 50/75; B60L 58/40; H01M 2250/20; H01M 2220/20; B60L 2240/547; B60L 2240/549

(57) ABSTRACT

When a voltage measurement value of a first voltage sensor that measures voltage at a direct current end of an inverter exceeds an overvoltage threshold value, and a battery is non-chargeable, a controller of a fuel cell electric vehicle is configured to drive an electric power consumption device until the voltage measurement value falls below the overvoltage threshold value. When the voltage measurement value exceeds the overvoltage threshold value and the battery can be charged, the controller is configured to cause the fuel cell electric vehicle to continue traveling, while estimating the voltage at the direct current end using a second voltage sensor that measures output voltage of a fuel cell stack or a third voltage sensor that measures output voltage of the battery.

### CROSS-REFERENCE TO RELATED APPLICATION

This application claims priority to Japanese Patent Application No. 2021-121572 filed on Jul. 26, 2021, incorporated herein by reference in its entirety.

### BACKGROUND

### 1. Technical Field

The technology disclosed in the present specification relates to a fuel cell electric vehicle and a control method of the same.

### 2. Description of Related Art

Fuel cell electric vehicles are provided with a battery, in addition to a fuel cell. The battery stores excess electric power from the fuel cell, and regenerative electric power generated by a motor generator. Now, the structure of the motor generator is the same as that of an ordinary electric motor. The motor generator can output torque for traveling, by using electric power from the fuel cell or the battery, and can also generate electricity by using inertial energy of the vehicle. The fuel cell and the battery supply electric power to the motor generator via an inverter.

When the amount of excess electric power exceeds that which the battery can take on, the voltage on the electric power lines of the inverter and fuel cell may exceed an overvoltage threshold value. In technology described in Japanese Unexamined Patent Application Publication No. 2010-273496 (JP 2010-273496 A), output of a fuel cell stack is adjusted so that overvoltage does not occur.

### SUMMARY

A fuel cell electric vehicle is provided with a voltage sensor that measures voltage at a direct current end of an inverter. A controller of the fuel cell electric vehicle determines whether overvoltage is occurring, based on measurement values of the voltage sensor. However, when an abnormality occurs at the voltage sensor, the voltage sensor may output a measurement value higher than an overvoltage threshold value, even though overvoltage is not actually occurring. In such a case, the controller may erroneously determine that overvoltage has occurred. The present specification provides a fuel cell electric vehicle that can continue to travel using an alternative voltage sensor even when the measurement value of the voltage sensor exceeds the overvoltage threshold value when an abnormality is occurring in the voltage sensor, and a control method thereof.

The fuel cell electric vehicle disclosed in the present specification includes a fuel cell stack, a battery, a motor generator, an inverter, a first voltage sensor, an electric power consumption device, and a controller. The motor generator is configured to use electric power from the fuel cell stack and the battery to output torque for traveling, and to use inertial energy of the fuel cell electric vehicle to generate electricity. The fuel cell stack and the battery are connected to a direct current end of the inverter, and the motor generator is connected to an alternating current end of the inverter. The first voltage sensor is configured to measure voltage at the direct current end of the inverter. The electric power consumption device is connected to the direct current end. An example of an electric power consumption device is a device for operating a fuel cell stack (fuel cell auxiliary device).

The controller is configured to drive the electric power consumption device when a measurement value (voltage measurement value) of the first voltage sensor exceeds an overvoltage threshold value and the battery is in a non-chargeable state, until the voltage measurement value falls below the overvoltage threshold value. The controller is configured to determine that an abnormality has occurred at the first voltage sensor when the voltage measurement value exceeds the overvoltage threshold value and the battery is in a chargeable state. When determination is made that an abnormality has occurred at the first voltage sensor, the controller is configured to drive the motor generator while estimating the voltage at the direct current end using a second voltage sensor that measures output voltage of the fuel cell stack or a third voltage sensor that measures output voltage of the battery (using a voltage sensor that is separate from the first voltage sensor).

When the battery is in a chargeable state, excess electric power will be taken on by the battery, and no overvoltage occurs. When the measurement value of the first voltage sensor indicates the overvoltage threshold value regardless of this, determination can be made that an abnormality has occurred at the first voltage sensor. In such a case, the controller is configured to drive the motor generator while estimating the voltage at the direct current end of the inverter using the second voltage sensor or the third voltage sensor. That is to say, the vehicle can continue traveling. On the other hand, when the battery is in a non-chargeable state, overvoltage may occur, and accordingly determination can be made that the measurement value of the first voltage sensor is correct. In such a case, the controller is configured to drive the electric power consumption device to resolve the overvoltage.

A typical case in which the battery is in the non-chargeable state may be a case in which the battery is electrically isolated from the direct current end of the inverter. The controller may be configured to determine that the battery is in the non-chargeable state when a measurement value of a current sensor that measures current flowing in and out of the battery indicates zero. The controller may be configured to determine that the battery is in the non-chargeable state when voltage of the battery exceeds the voltage at the direct current end of the inverter.

In the fuel cell electric vehicle according to the present disclosure, an allowable voltage upper limit value set for the electric power consumption device may be higher than an output voltage upper limit value of the fuel cell stack.

In the fuel cell electric vehicle according to the present disclosure, the direct current end of the inverter may be connected to the fuel cell stack via a boost converter, and the controller may be configured to multiply a measurement value of the second voltage sensor by a boost ratio of the boost converter to estimate the voltage at the direct current end.

In the fuel cell electric vehicle according to the present disclosure, the battery and the inverter may be connected without a voltage converter interposed between the battery and the inverter, and the controller may be configured to use a measurement value of the third voltage sensor as a voltage estimation value at the direct current end of the inverter.

In a control method of a fuel cell electric vehicle disclosed in the present specification, the fuel cell electric vehicle includes a fuel cell stack, a battery, a motor generator that is configured to use electric power from the fuel cell stack and the battery to output torque for traveling, and is configured to use inertial energy of the fuel cell electric vehicle to generate electricity, an inverter of which a direct current end is connected to the fuel cell stack and the battery, and of which an alternating current end is connected to the motor generator, a first voltage sensor configured to measure voltage at the direct current end, an electric power consumption device connected to the direct current end, and a controller. The control method of the fuel cell electric vehicle according to the present disclosure includes determining, by the controller, whether the battery is in a non-chargeable state or a chargeable state, when a measurement value of the first voltage sensor exceeds an overvoltage threshold value, driving, by the controller, the electric power consumption device until the measurement value falls below the overvoltage threshold value when determination is made that the battery is in the non-chargeable state, and driving, by the controller, the motor generator when determination is made that the battery is in the chargeable state, while estimating the voltage at the direct current end using a second voltage sensor that measures output voltage of the fuel cell stack or a third voltage sensor that measures output voltage of the battery.

In the control method of the fuel cell electric vehicle according to the present disclosure, the controller may be configured to determine that the battery is in the non-chargeable state when the battery is electrically isolated from the direct current end.

In the control method of the fuel cell electric vehicle according to the present disclosure, the controller may be configured to determine that the battery is in the non-chargeable state when the measurement value of the current sensor configured to measure a current flowing in and out of the battery indicates zero.

Details of the technique disclosed in the present specification and further improvements will be described in the “DETAILED DESCRIPTION OF EMBODIMENTS” below.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a block diagram of an electric power system of a fuel cell electric vehicle according to an embodiment; and

FIG. 2 is a flowchart of processing when a measurement value of a first voltage sensor exceeds an overvoltage threshold value.

### DETAILED DESCRIPTION OF EMBODIMENTS

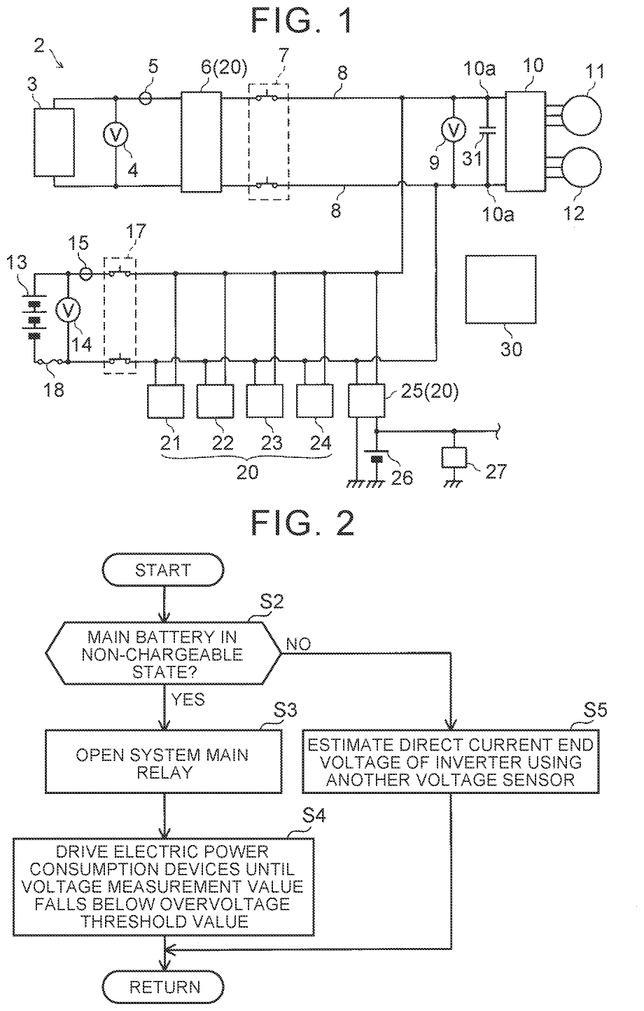

A fuel cell electric vehicle 2 according to an embodiment will be described with reference to the drawings. FIG. 1 is a block diagram of an electric power system of the fuel cell electric vehicle 2. The fuel cell electric vehicle 2 according to the embodiment includes a fuel cell stack 3, a boost converter 6, an inverter 10, a motor generator 11 for traveling, a main battery 13, and a controller 30. The fuel cell electric vehicle 2 travels by driving the motor generator 11 for traveling using electric power of the fuel cell stack 3 and the main battery 13.

The motor generator 11 can output torque for traveling, by using the electric power from the fuel cell stack 3 or the main battery 13, and can also generate electricity by using inertial energy of the fuel cell electric vehicle 2. The structure of the motor generator 11 is the same as that of an ordinary electric motor. It is well known that ordinary electric motors generate electricity when driven in reverse. Electric power generated by the motor generator 11 is called regenerative electric power. The regenerative electric power (alternating current) generated by the motor generator 11 is converted into direct current electric power by the inverter 10, and the main battery 13 is charged thereby.

The inverter 10 converts direct current electric power of the fuel cell stack 3 and the main battery 13 into three-phase alternating current electric power for driving the motor generator 11. The inverter 10 may convert the regenerative electric power (alternating current) generated by the motor generator 11 into direct current electric power, and output the direct current electric power from a direct current end 10a, as described above. The fuel cell stack 3 is connected to the direct current end 10a of the inverter 10 via a fuel cell (FC) relay 7 and the boost converter 6. The boost converter 6 boosts output electric power of the fuel cell stack 3 and supplies the boosted electric power to the inverter 10.

The FC relay 7 is opened when a main switch of the fuel cell electric vehicle 2 is off, thereby electrically disconnecting the fuel cell stack 3 from the inverter 10. The FC relay 7 is controlled by the controller 30. The controller 30 activates the fuel cell stack 3 when the main switch of the fuel cell electric vehicle 2 is turned on. When the output of the fuel cell stack 3 reaches a predetermined voltage (starting voltage), the controller 30 closes the FC relay 7 and connects the fuel cell stack 3 to the inverter 10. When the fuel cell stack 3 is stopped, or when an abnormality occurs in the fuel cell stack 3, the controller 30 opens the FC relay 7 and electrically disconnects the fuel cell stack 3 from the inverter 10. The direct current end 10a of the inverter 10, the fuel cell stack 3, and the main battery 13 are connected by a power line 8.

The inverter 10 includes two inverter circuits. The two inverter circuits have the direct current end 10a in common. An alternating current end of one inverter circuit is connected to the motor generator 11, and an alternating current end of the other inverter circuit is connected to an air compressor 12. The air compressor 12 is a device for feeding air to the fuel cell stack 3. The inverter 10 is controlled by the controller 30. The controller 30 decides a target output of the motor generator 11 based on a throttle valve opening degree and a vehicle speed, and controls one of the inverter circuits of the inverter 10 so that the target output is realized. Further, the controller 30 decides a target output of the fuel cell stack 3 and controls the other inverter circuit so that the target output is realized.

A smoothing capacitor 31 and a voltage sensor 9 (an example of a first voltage sensor) are connected to the direct current end 10a of the inverter 10. The smoothing capacitor 31 suppresses pulsation of the electric power input to the inverter 10. The voltage sensor 9 measures voltage at the direct current end 10a of the inverter 10. The measurement value of the voltage sensor 9 is sent to the controller 30.

A voltage sensor 4 (an example of a second voltage sensor) and a current sensor 5 are connected to an output end of the fuel cell stack 3. The voltage sensor 4 measures output voltage of the fuel cell stack 3, and the current sensor 5 measures output current of the fuel cell stack 3. The measurement values of the voltage sensor 4 and the current sensor 5 are sent to the controller 30. Note that in FIG. 1, a communication line for transmitting sensor information such as measurement values, and a signal line for transmitting commands sent from the controller 30 to the inverter 10 and so forth, are omitted from illustration.

The main battery 13 is connected to the direct current end 10a of the inverter 10 via a system main relay 17. When the main switch of the fuel cell electric vehicle 2 is turned on, the controller 30 closes the system main relay 17 and connects the main battery 13 to the inverter 10. When the main switch is turned off, the controller 30 opens the system main relay 17 and electrically disconnects the main battery 13 from the inverter 10 (power line 8).

The main battery 13 is rechargeable, and typically is a lithium ion battery. The response speed of the main battery 13 is faster than the response speed of the fuel cell stack 3. When an accelerator pedal is depressed, the target torque of the motor generator 11 suddenly increases. When the output of the fuel cell stack 3 is not sufficient to achieve the target torque, the electric power of the main battery 13 is used.

The regenerative electric power described above is stored in the main battery 13, thereby charging the main battery 13. The excess electric power of the fuel cell stack 3 is also stored in the main battery 13. Other electrical devices are also connected to the power line 8 connecting the direct current end 10a of the inverter 10, the fuel cell stack 3, and the main battery 13. The term “excess electric power” means, out of electric power generated by the fuel cell stack 3 and regenerative electric power described above, the electric power that remains unconsumed by the electric devices (including the inverter 10) connected to the power line 8.

A voltage sensor 14 (an example of a third voltage sensor) and a current sensor 15 are also connected to the main battery 13. The voltage sensor 14 measures output voltage of the main battery 13, and the current sensor 15 measures a current flowing in and out of the main battery 13. The measurement values of the voltage sensor 14 and the current sensor 15 are sent to the controller 30. The main battery 13 is also provided with a fuse 18.

In addition to the inverter 10, the electric devices connected to the power line 8 include a hydrogen pump 21, a cooler pump 22, a heater 23, an air conditioner 24, a voltage converter 25, and the like. The hydrogen pump 21 is a device that feeds hydrogen gas to the fuel cell stack 3, and the cooler pump 22 is a device that circulates coolant of the fuel cell stack 3. The heater 23 is a device that heats the fuel cell stack 3 when the temperature of the fuel cell stack 3 is low. The air conditioner 24 is a device that adjusts the temperature inside a vehicle cabin of the fuel cell electric vehicle 2.

The voltage converter 25 steps down the voltage of the fuel cell stack 3 or the main battery 13, and supplies the voltage to a low-power device such as an audio device 27 or the like. A sub-battery 26 is charged by the output of the voltage converter 25.

In FIG. 1, each of the hydrogen pump 21, the cooler pump 22, and the air conditioner 24 is drawn as a single rectangle, but these devices each include an actuator such as a pump or the like, and a driver for driving the actuator. The driver includes switching elements called power transistors, and withstand voltage is set for these switching elements. The voltage converter 25 that receives electric power supply via the power line 8, and the boost converter 6 connected between the fuel cell stack 3 and the inverter 10, also have switching elements, and withstand voltage is also set for these switching elements. When voltage applied to these switching elements exceeds the withstand voltage, the switching elements may be damaged.

Accordingly, the controller 30 monitors the voltage on the power line 8 (in other words, the voltage of the direct current end 10a of the inverter 10), and controls the fuel cell stack 3 and the boost converter 6 so that the voltage at the direct current end 10a does not exceed a predetermined overvoltage threshold value. Alternatively, the controller 30 drives an electric device that receives supply of electric power from the fuel cell stack 3 or the inverter 10 (inverter 10 when outputting regenerative electric power) via the power line 8. That is to say, the controller 30 lowers the voltage at the direct current end 10a by consuming the electric power transmitted through the power line 8 at the electric devices. Hereinafter, electric devices that receive supply of electric power from the fuel cell stack 3 and the inverter 10 (the inverter 10 when outputting regenerative electric power) via the power line 8 will be collectively referred to as “electric power consumption devices 20”, for the sake of convenience of description. The electric power consumption devices 20 include the hydrogen pump 21, the cooler pump 22, the heater 23, the air conditioner 24, the voltage converter 25, and the boost converter 6.

An allowable voltage upper limit value is set for the electric power consumption devices 20. The allowable voltage upper limit value is set to be higher than an output voltage upper limit value of the fuel cell stack 3 and the inverter 10 (inverter 10 when outputting regenerative electric power). The allowable voltage upper limit value is set to a value that is lower than the aforementioned withstand voltage and does not cause damage to the electric power consumption devices 20 due to overvoltage. The allowable voltage upper limit value may be the same as the aforementioned overvoltage threshold value.

The controller 30 monitors the voltage of the direct current end 10a (power line 8) of the inverter 10 by using the measurement value of the voltage sensor 9. However, when an abnormality occurs in the voltage sensor 9, a state may occur in which the measurement value of the voltage sensor 9 exceeds the overvoltage threshold value, even though the actual voltage of the direct current end 10a is not exceeding the overvoltage threshold value. When the measurement value of the voltage sensor 9 exceeds the overvoltage threshold value, the controller 30 can determine whether an abnormality has occurred at the voltage sensor 9, and can take appropriate measures in accordance with whether there actually is an abnormality.

The direct current end 10a and the main battery 13 are connected, and accordingly the voltage of the direct current end 10a does not exceed the overvoltage threshold value so long as the main battery 13 can be charged. When the measurement value of the voltage sensor 9 exceeds the overvoltage threshold value even though the main battery 13 is connected to the direct current end 10a, determination can be made that an abnormality has occurred at the voltage sensor 9. On the other hand, when the main battery 13 cannot be charged, there is a possibility that the voltage at the direct current end 10a will exceed the overvoltage threshold value. In this case, the measurement value of the voltage sensor 9 is very likely to be correct.

Accordingly, when the main battery 13 is in a chargeable state, and the measurement value of the voltage sensor 9 exceeds the overvoltage threshold value, the controller 30 determines that an abnormality has occurred at the voltage sensor 9. In this case, the controller 30 uses another voltage sensor (e.g., the voltage sensor 4 that measures the voltage of the fuel cell stack 3, or the voltage sensor 14 that measures the voltage of the main battery 13), to estimate the voltage at the direct current end 10a.

FIG. 2 shows processing when the measurement value of the voltage sensor 9 exceeds the overvoltage threshold value. When the measurement value of the voltage sensor 9 exceeds the overvoltage threshold value, the controller 30 checks the state of the main battery 13 (step S2). When the main battery 13 is in a non-chargeable state (YES in step S2), the controller 30 opens the system main relay 17 (step S3). An example of a non-chargeable state of the main battery 13 is a case in which the main battery 13 is electrically isolated from the fuel cell stack 3 and the inverter 10. For example, when the fuse 18 is blown, the main battery 13 is isolated from the fuel cell stack 3 and the inverter 10, and cannot be charged. Even in such a case, the controller 30 opens the system main relay 17, as a preventive measure. Note that in this case, it is very likely that the voltage sensor 9 is operating normally.

Next, the controller 30 drives the electric power consumption devices 20 until the measurement value (voltage measurement value) of the voltage sensor 9 falls below the overvoltage threshold value (step S4).

After step S4, the controller 30 causes the fuel cell electric vehicle 2 to continue traveling. Note that the system main relay 17 is open (step S3), and accordingly the controller 30 causes the fuel cell electric vehicle 2 to continue traveling without using the main battery 13. In this case, the excess electric power cannot be taken on, and accordingly the controller 30 lowers the output of the fuel cell stack 3 as compared with normal operations.

On the other hand, in step S2, when the main battery 13 is in a chargeable state (NO in step S2), the controller 30 determines that an abnormality has occurred at the voltage sensor 9. In this case, the controller 30 uses another voltage sensor (e.g., the voltage sensor 4 that measures the voltage of the fuel cell stack 3, or the voltage sensor 14 that measures the voltage of the main battery 13), to estimate the voltage at the direct current end 10a of the inverter 10 (step S5). Multiplying the measurement value of the voltage sensor 4 by a boost ratio of the boost converter 6 yields a voltage estimation value at the direct current end 10a. Further, the measurement value of the voltage sensor 14 (voltage of the main battery 13) can be used, without change, as a voltage estimation value of the direct current end 10a.

The controller 30 causes the fuel cell electric vehicle 2 to continue traveling using the voltage estimation value. Specifically, the controller 30 controls the fuel cell stack 3 and the boost converter 6 so that the voltage estimation value (estimated value of the voltage at the direct current end 10a) does not exceed the overvoltage threshold value. After step S5, the controller 30 drives the motor generator 11 and causes the fuel cell electric vehicle 2 to travel, while estimating the voltage at the direct current end 10a using another voltage sensor that measures the output voltage of the fuel cell stack 3 or the main battery 13.

Note that when detecting any of the following (1) to (3), the controller 30 determines that the main battery 13 cannot be charged. (1) When the main battery 13 is electrically separated from the fuel cell stack 3 and the inverter 10. A situation in which the fuse 18 is blown, or the system main relay 17 is open, corresponds to this case.

(2) When the measurement value of the current sensor 15 that measures the current flowing through the main battery 13 indicates zero. When the measurement value of the current sensor 15 indicates zero, this also is an indication that the main battery 13 is electrically separated from the fuel cell stack 3 and the inverter 10.

(3) When the voltage of the main battery 13 exceeds the voltage of the direct current end 10a. In this case, the main battery 13 cannot take on the electric power being applied to the direct current end 10a.

As described above, in the fuel cell electric vehicle 2 according to the embodiment, even when the measurement value of the voltage sensor 9 exceeds the overvoltage threshold value, when an abnormality is occurring in the voltage sensor 9, an alternative voltage sensor (the voltage sensor 4 or the voltage sensor 14) can be used to continue traveling. Also, when the voltage sensor 9 can be determined to be normal, the electric power consumption devices 20 are driven until the voltage at the direct current end 10a falls below the overvoltage threshold value. According to this processing, the overvoltage state is quickly resolved, and damage to the devices connected to the power line 8 can be suppressed.

Points to be noted regarding the technology described in the embodiment will be described. In step S2 in FIG. 2, the controller 30 determines that the battery can be charged when the main battery 13 is connected to the direct current end 10a, and the voltage of the main battery 13 is the same as the voltage of the direct current end 10a.

In the fuel cell electric vehicle 2 according to the embodiment, no voltage converter is connected between the main battery 13 and the inverter 10. In other words, drive voltage of the inverter 10 is substantially equal to the output voltage of the main battery 13. In this case, the resistance value of the electric power line between the direct current end 10a of the inverter 10 and the main battery 13 is small. Accordingly, when the voltage of the main battery 13 is the same as the voltage of the direct current end 10a, excess voltage is quickly stored in the main battery 13.

While specific examples of the disclosure have been described in detail above, these are merely exemplary, and do not limit the scope of the claims. The technology set forth in the claims includes various modifications and variations of the specific examples exemplified above. The technical elements described in the present specification or drawings exhibit technical utility alone or in various combinations, and are not limited to the combinations described in the claims at the time of application. The technology exemplified in the present specification or the drawings can achieve a plurality of objects at the same time, and achieving one of the objects itself has technical utility.

What is claimed is:

1. A fuel cell electric vehicle, comprising:
a fuel cell stack;
a battery;
a motor generator that is configured to use electric power from the fuel cell stack and the battery to output torque for traveling, and is configured to use inertial energy of the fuel cell electric vehicle to generate electricity;
an inverter of which a direct current end is connected to the fuel cell stack and the battery, and of which an alternating current end is connected to the motor generator;
a first voltage sensor configured to measure voltage at the direct current end;
an electric power consumption device connected to the direct current end; and
a controller configured to
drive the electric power consumption device when a measurement value of the first voltage sensor exceeds an overvoltage threshold value, and the battery is in a non-chargeable state, until the measurement value falls below the overvoltage threshold value, and
drive the motor generator when the measurement value exceeds the overvoltage threshold value, and the battery is in a chargeable state, while estimating the voltage at the direct current end using a second voltage sensor that measures output voltage of the fuel cell stack or a third voltage sensor that measures output voltage of the battery.

2. The fuel cell electric vehicle according to claim 1, wherein the controller is configured to determine that the battery is in the non-chargeable state when the battery is electrically isolated from the direct current end.

3. The fuel cell electric vehicle according to claim 1, further comprising a current sensor configured to measure a current flowing in and out of the battery, wherein the controller is configured to determine that the battery is in the non-chargeable state when a measurement value of the current sensor indicates zero.

4. The fuel cell electric vehicle according to claim 1, wherein the controller is configured to determine that the battery is in the non-chargeable state when voltage of the battery exceeds the voltage of the direct current end.

5. The fuel cell electric vehicle according to claim 1, wherein an allowable voltage upper limit value set for the electric power consumption device is higher than an output voltage upper limit value of the fuel cell stack.

6. The fuel cell electric vehicle according to claim 1, wherein:
the direct current end is connected to the fuel cell stack via a boost converter; and
the controller is configured to estimate the voltage at the direct current end by multiplying a measurement value of the second voltage sensor by a boost ratio of the boost converter.

7. The fuel cell electric vehicle according to claim 1, wherein:
the battery and the inverter are connected without a voltage converter interposed between the battery and the inverter; and
the controller is configured to use a measurement value of the third voltage sensor as a voltage estimation value at the direct current end.

8. A control method of a fuel cell electric vehicle, the fuel cell electric vehicle including
a fuel cell stack,
a battery,
a motor generator that is configured to use electric power from the fuel cell stack and the battery to output torque for traveling, and is configured to use inertial energy of the fuel cell electric vehicle to generate electricity,
an inverter of which a direct current end is connected to the fuel cell stack and the battery, and of which an alternating current end is connected to the motor generator,
a first voltage sensor configured to measure voltage at the direct current end,
an electric power consumption device connected to the direct current end, and
a controller,
the control method comprising:
determining, by the controller, whether the battery is in a non-chargeable state or a chargeable state, when a measurement value of the first voltage sensor exceeds an overvoltage threshold value;
driving, by the controller, the electric power consumption device until the measurement value falls below the overvoltage threshold value when determination is made that the battery is in the non-chargeable state; and
driving, by the controller, the motor generator when determination is made that the battery is in the chargeable state, while estimating the voltage at the direct current end using a second voltage sensor that measures output voltage of the fuel cell stack or a third voltage sensor that measures output voltage of the battery.

9. The control method according to claim 8, wherein the controller is configured to determine that the battery is in the non-chargeable state when the battery is electrically isolated from the direct current end.

10. The control method according to claim 8, wherein the controller is configured to determine that the battery is in the non-chargeable state when a measurement value of a current sensor configured to measure a current flowing in and out of the battery indicates zero.
